(19) United States
(12) Patent Application Publication
(10) Pub. No.: US 2005/0082264 A1
(43) Pub. Date: Apr. 21, 2005

(54) Laser beam machine

(76) Inventors: Yusuke Nagai, Tokyo (JP); Satoshi Kobayashi, Tokyo (JP); Yukio Morishige, Tokyo (JP); Masaru Nakamura, Tokyo (JP); Masahiro Murata, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/961,219

(22) Filed: Oct. 12, 2004

(30) Foreign Application Priority Data
Oct. 15, 2003 (JP) 2003-355297

(51) Int. Cl. B23K 26/00

(52) U.S. Cl. 219/121.62; 219/121.61

(57) ABSTRACT

A laser beam machine comprising a chuck table for holding a workpiece and a laser beam application means for applying a laser beam to the workpiece held on the chuck table, wherein the machine further comprises a light detection means for detecting light of a processing portion of the workpiece to which a laser beam is applied from the laser beam application means and a control means for judging whether the output value of the light detection means falls within a predetermined permissible range.

### FIELD OF THE INVENTION

The present invention relates to a laser beam machine for carrying out predetermined processing by applying a laser beam to a workpiece.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer and a circuit (device) such as IC or LSI is formed in each of the sectioned areas. Individual semiconductor chips are manufactured by cutting this semiconductor wafer along the streets to divide it into areas having the circuit thereon formed. An optical device wafer comprising gallium nitride-based compound semiconductors laminated on the front surface of a sapphire substrate is also cut along streets to be divided into individual optical devices such as light emitting diodes or laser diodes, which are widely used in electric equipment.

Cutting along the streets of the above semiconductor wafer or optical device wafer-is generally carried out by a cutting machine called “dicer”. This cutting machine comprises a chuck table for holding a workpiece such as a semiconductor wafer or optical device wafer, a cutting means for cutting the workpiece held on the chuck table, and a moving means for moving the chuck table and the cutting means relative to each other. The cutting means has a spindle unit, which comprises a rotary spindle, a cutting blade mounted to the spindle and a drive mechanism for rotary-driving the rotary spindle. The cutting blade comprises a disk-like base and an annular edge that is mounted to the side wall outer peripheral portion of the base and formed as thick as about 20 μm by fixing diamond abrasive grains having a diameter of about 3 μm to the base by electro forming.

Since a sapphire substrate, silicon carbide substrate, and the like have high Mohs hardness, cutting with the above cutting blade is not always easy. Since the cutting blade has a thickness of about 20 μm, the streets for sectioning devices need to have a width of about 50 μm. Therefore, in the case of a device measuring about 300 μm×300 μm, the area ratio of the streets to the wafer is large, thereby reducing productivity.

Meanwhile, as a means of dividing a plate-like workpiece such as a semiconductor wafer, a laser beam processing method for applying a pulse laser beam capable of passing through the workpiece with its focusing point on the inside of the area to be divided is attempted and disclosed by JP-A 2002-192367, for example. In the dividing method using this laser beam processing technique, a workpiece is divided by applying a pulse laser beam having an infrared range, capable of passing through the workpiece, to one side of the workpiece with its focusing point set to the inside thereof to continuously form deteriorated layers in the inside of the workpiece along the streets and applying external force along the streets whose strength has been reduced by the formation of the deteriorated layers.

To divide the workpiece having deteriorated layers formed in the inside along the deteriorated layers without fail, it is important that the deteriorated layers should be uniformly exposed to the top surface of the workpiece. Although the focusing point of the pulse laser beam is set to a position of a predetermined distance from the top surface of the workpiece so that the deteriorated layers are exposed to the top surface of the workpiece, the deteriorated layers may not be able to be uniformly exposed to the top surface of the workpiece when the top surface of the workpiece has undulation. In this case, a processing failure area that is difficult to be divided along the deteriorated layers is produced.

### SUMMARY OF THE INVENTION

It is an object of the present invention to provide a laser beam machine capable of detecting a processing failure area in which a deteriorated layer formed in the inside of a workpiece by applying a laser beam to the workpiece is not exposed to the top surface of the workpiece.

To attain the above object, according to the present invention, there is provided a laser beam machine comprising a chuck table for holding a workpiece and a laser beam application means for applying a laser beam to the workpiece held on the chuck table, wherein
the machine further comprises a light detection means for detecting light of a processing portion of the workpiece to which a laser beam is applied from the laser beam application means and a control means for judging whether the output value of the light detection means falls within a predetermined permissible range.

The above light detection means comprises a photodiode, which detects a laser beam applied to the processing portion by the above laser beam application means and converts the intensity of its diffused light into a voltage value. The above light detection means has an illuminating light source for applying light having a wavelength different from the wavelength of the laser beam applied from the above laser beam application means to the processing portion and a photo diode for detecting a reflected light of the light applied to the processing portion from the illuminating light source and converting the intensity of its reflected light into a voltage value. Preferably, the above light detection means further comprises a filter for cutting off light having the same wavelength as the wavelength of the laser beam applied from the above laser beam application means out of the light reflected from the processing portion.

Preferably, the above control means comprises a storage means for storing the output value of the above light detection means as failure site data when the output value does not fall within the predetermined permissible range.

In the present invention, since a processing failure can be confirmed by judging whether the output value of the light detection means for detecting light of the processing portion falls within the predetermined permissible range, re-processing can be carried out according to circumstances, or the data can be effectively used for the analysis of a failure, etc.

### BRIEF DESCRIPTION OF THE DRAWINGS

FIG. 1 is a perspective view of a laser beam machine constituted according to the present invention;

FIG. 2 is a block diagram schematically showing the constitution of a laser beam application means provided in the laser beam machine shown in FIG. 1;

FIG. 3 is a schematic diagram for explaining the focusing spot diameter of a pulse laser beam;

FIG. 4 is a perspective view of a semiconductor wafer as a workpiece;

FIGS. 5(a) and 5(b) are diagrams showing a state where a deteriorated layer is formed in the inside of the workpiece held on the chuck table of the laser beam machine shown in FIG. 1;

FIG. 6 is a diagram showing a state where a laminate of deteriorated layers are formed in the inside of the workpiece;

FIG. 7 is a diagram showing a state where the light of a processing portion of the workpiece is detected by the light detection means provided in the laser beam machine shown in FIG. 1;

FIG. 8 is a diagram showing the output signal of the light detection means provided in the laser beam machine shown in FIG. 1; and

FIG. 9 is a block diagram showing another example of the light detection means provided in the laser beam machine.

### DETAILED DESCRIPTION OF THE PREFERRED EMBODIMENTS

A laser beam machine according to preferred embodiments of-the present invention will be described in detail herein under with reference to the accompanying drawings.

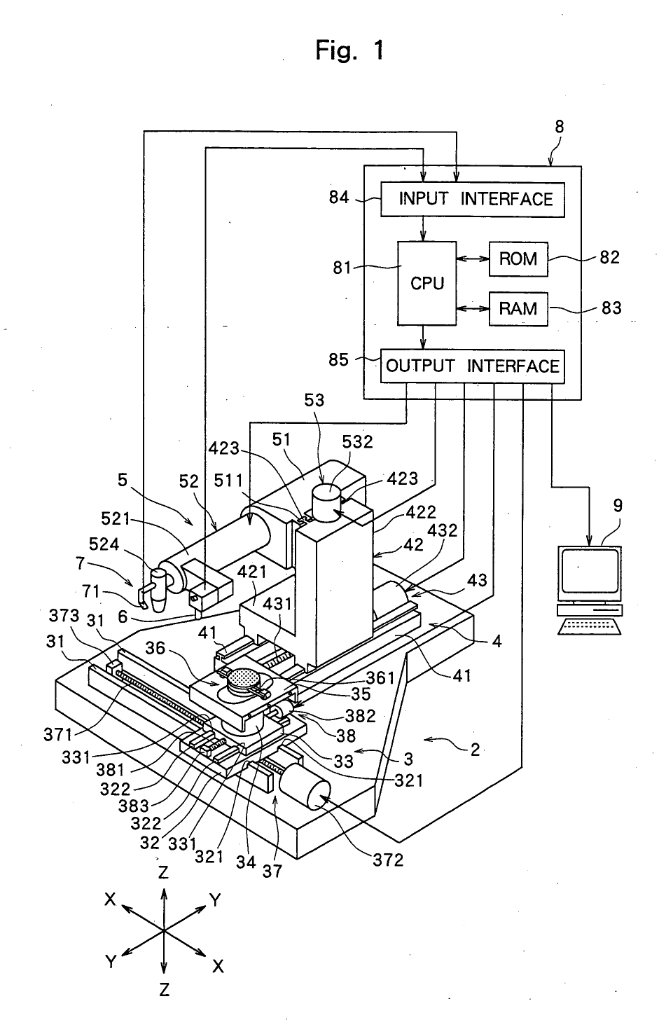

FIG. 1 is a perspective view of the laser beam machine constituted according to the present invention. The laser beam machine shown in FIG. 1 comprises a stationary base 2, a chuck table mechanism 3 for holding a workpiece, which is mounted on the stationary base 2 in such a manner that it can move in a processing-feed direction indicated by an arrow X, a laser beam application unit support mechanism 4 mounted on the stationary base 2 in such a manner that it can move in an indexing-feed direction indicated by an arrow Y perpendicular to the direction indicated by the arrow X, and a laser beam application unit 5 mounted to the laser beam application unit support mechanism 4 in such a manner that it can move in a direction indicated by an arrow Z.

The above chuck table mechanism 3 comprises a pair of guide rails 31 and 31 mounted on the stationary base 2 and arranged parallel to each other in the direction indicated by the arrow X, a first sliding block 32 mounted on the guide rails 31 and 31 in such a manner that it can move in the direction indicated by the arrow X, a second sliding block 33 mounted on the first sliding block 32 in such a manner that it can move in the direction indicated by the arrow Y, a support table 35 supported on the second sliding block 33 by a cylindrical member 34, and a chuck table 36 as a workpiece holding means. This chuck table 36 has an adsorption chuck 361 made of a porous material so that a disk-like wafer as a workpiece is held on the adsorption chuck 361 by a suction means that is not shown. The chuck table 36 is rotated by a pulse motor (not shown) installed in the cylindrical member 34.

The above first sliding block 32 has, on its undersurface, a pair of to-be-guided grooves 321 and 321 to be fitted to the above pair of guide rails 31 and 31 and, on its top surface, a pair of guide rails 322 and 322 formed parallel to each other in the direction indicated by the arrow Y. The first sliding block 32 constituted as described above can move in the direction indicated by the arrow X along the pair of guide rails 31 and 31 by fitting the to-be-guided grooves 321 and 321 to the pair of guide rails 31 and 31, respectively. The chuck table mechanism 3 in the illustrated embodiment has a processing-feed means 37 for moving the first sliding block 32 along the pair of guide rails 31 and 31 in the processing-feed direction indicated by the arrow x. The processing-feed means 37 has a male screw rod 371 arranged between the above pair of guide rails 31 and 31 in parallel thereto and a drive source such as a pulse motor 372 for rotary-driving the male screw rod 371. The male screw rod 371 is, at its one end, rotatably supported to a bearing block 373 fixed on the above stationary base 2 and is, at its other end, connected to the output shaft of the above pulse motor 372 by a speed reducer that is not shown. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the processing-feed direction indicated by the arrow X.

The above second sliding block 33 has, on its undersurface, a pair of to-be-guided grooves 331 and 331 to be fitted to the pair of guide rails 322 and 322 on the top surface of the above first sliding block 32 and can move in the indexing-feed direction indicated by the arrow Y by fitting the to-be-guided grooves 331 and 331 to the pair of guide rails 322 and 322, respectively. The chuck table mechanism 3 in the illustrated embodiment comprises a first indexing means 38 for moving the second sliding block 33 in the -indexing-feed-direction indicated by the arrow Y along the pair of guide rails 322 and 322 on the first sliding block 32. The first indexing means 38 has a male screw rod 381 that is arranged between the above pair of guide rails 322 and 322 in parallel thereto, and a drive source such as a pulse motor 382 for rotary-driving the male screw rod 381. The male screw rod 381 is, at its one end, rotatably supported to a bearing block 383 fixed on the top surface of the above first sliding block 32 and is, at its other end, connected to the output shaft of the above pulse motor 382 by a speed reducer that is not shown. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the indexing-feed direction indicated by the arrow Y.

The above laser beam application unit support mechanism 4 comprises a pair of guide rails 41 and 41 mounted on the stationary base 2 and arranged parallel to each other in the indexing-feed direction indicated by the arrow Y and a movable support base 42 mounted on the guide rails 41 and 41 in such a manner that it can move in the indexing-feed direction indicated by the arrow Y. This movable support base 42 comprises a movable support portion 421 movably mounted on the guide rails 41 and 41 and a mounting portion 422 mounted on the movable support portion 421. The mounting portion 422 is provided with a pair of guide rails 423 and 423 extending in the direction indicated by the arrow Z on one of its flanks. The laser beam application unit support mechanism 4 in the illustrated embodiment has a second indexing-feed means 43 for moving the movable support base 42 along the pair of guide rails 41 and 41 in the indexing-feed direction indicated by the arrow Y. This second indexing-feed means 43 has a male screw rod 431 arranged between the above pair of guide rails 41 and 41 in parallel thereto, and a drive source such as a pulse motor 432 for rotary-driving the male screw rod 431. The male screw rod 431 is, at its one end, rotatably supported to a bearing block (not shown) fixed on the above stationary base 2 and is, at its other end, connected to the output shaft of the above pulse motor 432 by a speed reducer that is not shown. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction with the pulse motor 432, the movable support base 42 is moved along the guide rails 41 and 41 in the indexing-feed direction indicated by the arrow Y.

The laser beam application unit 5 in the illustrated embodiment comprises a unit holder 51 and a laser beam application means 52 secured to the unit holder 51. The unit holder 51 has a pair of to-be-guided grooves 511 and 511 to be slidably fitted to the pair of guide rails 423 and 423 on the above mounting portion 422 and is supported in such a manner that it can move in the direction indicated by the arrow Z by fitting the to-be-guided grooves 511 and 511 to the above guide rails 423 and 423, respectively.

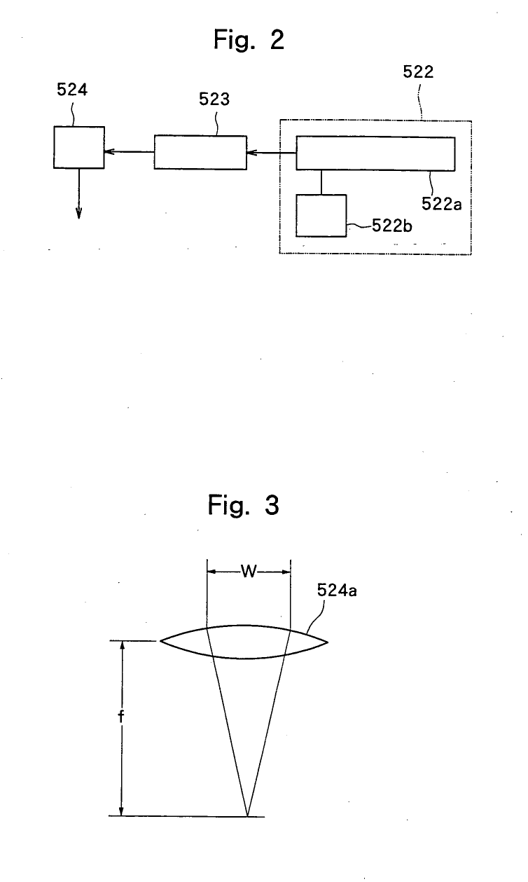

The illustrated laser beam application means 52 comprises a cylindrical casing 521 secured to the above unit holder 51 and extending substantially horizontally. In the casing 521, there are installed a pulse laser beam oscillation means 522 and a transmission optical system 523 as shown in FIG. 2. The pulse laser beam oscillation means 522 is constituted by a pulse laser beam oscillator 522a composed of a YAG laser oscillator or YVO4 laser oscillator and a repetition frequency setting means 522b connected to the pulse laser beam oscillator 522a. The transmission optical system 523 has suitable optical elements such as a beam splitter, etc. A condenser 524 housing condensing lenses (not shown) constituted by a set of lenses that may be a known formation is attached to the end of the above casing 521.

A laser beam oscillated from the above pulse laser beam oscillation means 522 reaches the condenser 524 through the transmission optical system 523 and is applied from the condenser 524 to the workpiece held on the above chuck table 36 at a predetermined focusing spot diameter D. This focusing spot diameter D is defined by the expression D(μm)=4×λ×f/(π×W) (wherein λ is the wavelength (μm) of the pulse laser beam, W is the diameter (mm) of a pulse laser beam applied to an objective lens 524a, and f is the focusing distance (mm) of the objective lens 524a) when the pulse laser beam having a Gauss distribution is applied through the objective lens 524a of the condenser 524 as shown in FIG. 3.

Returning to FIG. 1, an image pick-up means 6 is situated at the front end of the casing 521 constituting the above laser beam application means 52. This image pick-up means 6 in the illustrated embodiment is constituted by an infrared illuminating means for applying infrared radiation to the workpiece, an optical system for capturing infrared radiation applied by the infrared illuminating means, and an image pick-up device (infrared CCD) for outputting an electric signal corresponding to infrared radiation captured by the optical system, in addition to an ordinary image pick-up device (CCD) for picking up an image with visible radiation. An image signal is transmitted to a control means that will be described later.

The laser beam application unit 5 in the illustrated embodiment comprises a focusing point position adjusting means 53 for moving the unit holder 51 along the pair of guide rails 423 and 423 in the direction indicated by the arrow Z. The focusing point position adjusting means 53 has a male screw rod (not shown) arranged between the pair of guide rails 423 and 423 and a drive source such as a pulse motor 532 for rotary-driving the male screw rod. By driving the male screw rod (not shown) in a normal direction or reverse direction with the pulse motor 532, the unit holder 51 and the laser beam application means 52 are moved along the guide rails 423 and 423 in the direction indicated by the arrow Z. In the illustrated embodiment, the laser beam application means 52 is, so constituted as to move up by driving the pulse motor 532 in a normal direction and as to move down by driving the pulse motor 532 in the reverse direction. Therefore, the focusing point position adjusting means 53 can adjust the position of the focusing point of the laser beam applied by the condenser 524 attached to the end of the casing 521.

The laser beam machine in the illustrated embodiment has a light detection means 7 for detecting light of a processing portion of the workpiece which is held on the chuck table 36 and to which a laser beam is applied by the above laser beam application means 52. This light detection means 7 in the illustrated embodiment has a photodiode 71 attached to the above condenser 524, detects diffused light of the processing portion and transmits a detection signal corresponding to the intensity of the diffused light as a voltage signal to a control means 8 which will be described later. The control means 8 is composed of a computer which comprises a central processing unit (CPU) 81 for carrying out arithmetic processing based on a control program, a read-only memory (ROM) 82 for storing the control program, etc., a read/write random access memory (RAM) 83 for storing the results of operations, an input interface 84 and an output interface 85. Detection signals from the photodiode 71 and the image pick-up means 6 are applied to the input interface 84 of the control means 8 constituted as described above. Control signals are output from the output interface 85 to the above pulse motor 372, pulse motor 382, pulse motor 432, pulse motor 532, laser beam application means 52, display means 9 and the like.

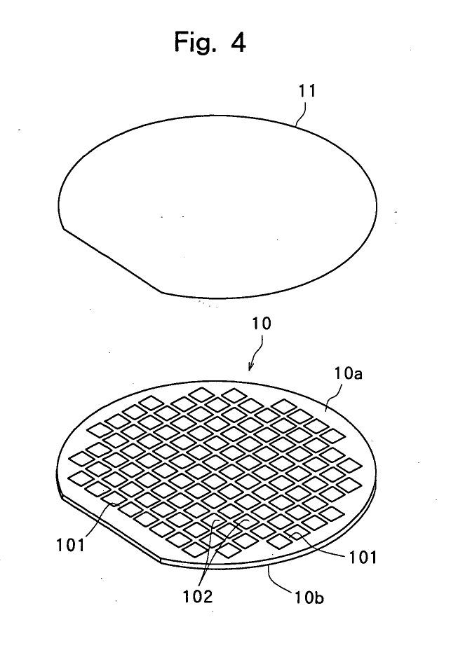

The laser beam machine in the illustrated embodiment is constituted as described above, and its operation of processing the semiconductor wafer 10 shown in FIG. 4 will be described hereinbelow.

In the semiconductor wafer 10 shown in FIG. 4, a plurality of areas are sectioned by a plurality of streets 101 formed in a lattice pattern on the front surface 10a of a semiconductor wafer such as a silicon wafer, and a circuit 102 such as IC or LSI is formed in each of the sectioned areas. The semiconductor wafer 10 constituted as described above has a protective tape 11 affixed to the front surface 10a and is placed, and suction-held, on the chuck table 36 in such a manner that the back surface 10b faces up. The chuck table 36 suction-holding the semiconductor wafer 10 is moved along the guide rails 31 and 31 by the operation of the processing-feed means 37 to be brought to a position right below the image pick-up means 6 mounted to the laser beam application unit 5.

After the chuck table 36 is positioned right below the image pick-up means 6, alignment work for detecting a processing area to be processed by a laser beam of the semiconductor wafer 10 is carried out by the image pick-up means 6 and the control means 8. That is, the image pick-up means 6 and the control means 8 carry out image processing such as pattern matching to align a street 101 formed in a predetermined direction of the semiconductor wafer 10 with the condenser 524 of the laser beam application unit 5 for applying a laser beam along the street 101, thereby performing the alignment of a laser beam application position. The alignment of the laser beam application position is also carried out on streets 101 formed on the semiconductor wafer 10 and extending in a direction perpendicular to the above predetermined direction. At this point, although the front surface 10a, on which the street 101 are formed, of the semiconductor wafer 10 faces down, the image of the street 101 can be taken from the back surface 10b as the image pick-up means 6 comprises an infrared illuminating means, an optical system for capturing infrared radiation and an image pick-up device (infrared CCD) for outputting an electric signal corresponding to the infrared radiation as described above.

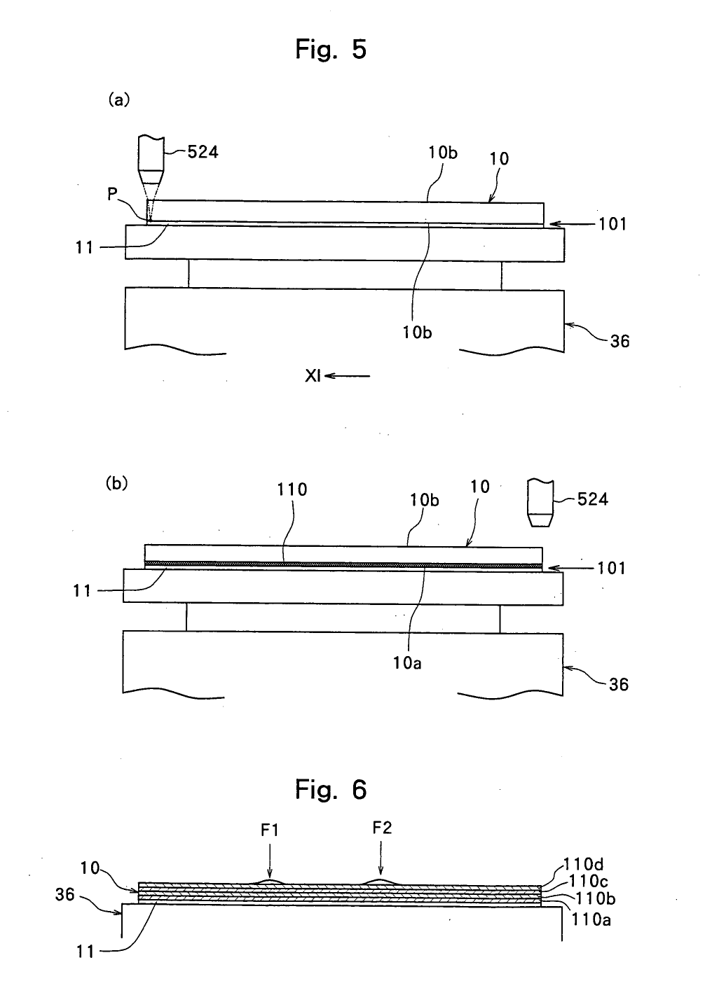

After the street 101 formed on the semiconductor wafer 10 held on the chuck table 36 is detected and the alignment of the laser beam application position is carried out as described above, the chuck table 36 is moved to a laser beam application range where the condenser 524 of the laser beam application means 52 for applying a laser beam is located, to bring one end (left end in FIG. 5(a)) of the predetermined street 101 to a position right below the condenser 524 of the laser beam application means 52 as shown in FIG. 5(a). The chuck table 36, that is, the semiconductor wafer 10 is moved in the direction indicated by the arrow X1 in FIG. 5(a) at a predetermined feed rate while a pulse laser beam capable of passing through the semiconductor wafer 10 is applied from the condenser 524. When the application position of the condenser 524 of the laser beam application means 52 reaches the other end (right end in FIG. 5(a)) of the street 101 as shown in FIG. 5(b), the application of the pulse laser beam is suspended and the movement of the chuck table 36, that is, the semiconductor wafer 10 is stopped. In this laser beam application step, by setting the focusing point P of the pulse laser beam to the vicinity of the front surface 10a (undersurface) of the wafer 10, a deteriorated layer 110 is formed toward the inside from the front surface 10a (undersurface).

The processing conditions in the above laser beam application step are set as follows, for example.
Light source: Nd: YVO4 pulse laser
Wavelength: 1,064 nm
Pulse energy: 40 μJ
Repetition frequency: 100 kHz
Pulse width: 25 ns
Focusing spot diameter: 1 μm
Peak power density of focusing point: 2.0×10E11 W/cm²
Processing feed rate: 100 mm/sec

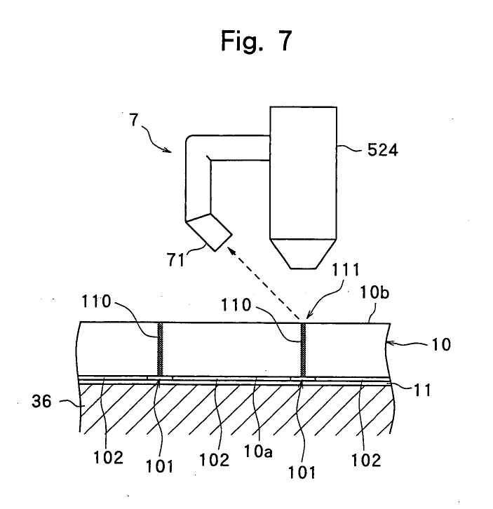

When the semiconductor wafer 10 is thick, the above laser beam application step is carried out several times by changing the focusing point P stepwise to form a plurality of deteriorated layers 110a, 110b, 110c and 110d as shown in FIG. 6. Although, in the illustrated embodiment, the uppermost deteriorated layer 110d is so set as to be exposed to the back surface 10b (top surface) of the semiconductor wafer 10, when the back surface 10b (top surface) has undulation and hence, the thickness of the semiconductor wafer 10 changes, areas F1 and F2 where the uppermost deteriorated layer 110d is not exposed to the back surface 10b (top surface) of the semiconductor wafer 10 are produced, as shown in FIG. 6. When there are such are as where the deteriorated layer is not exposed to the top surface, it becomes difficult to divide the semiconductor wafer 10 along the deteriorated layers.

The laser beam machine in the illustrated embodiment detects the existence of the areas F1 and F2 where the above deteriorated layer is not exposed to the top surface as follows.

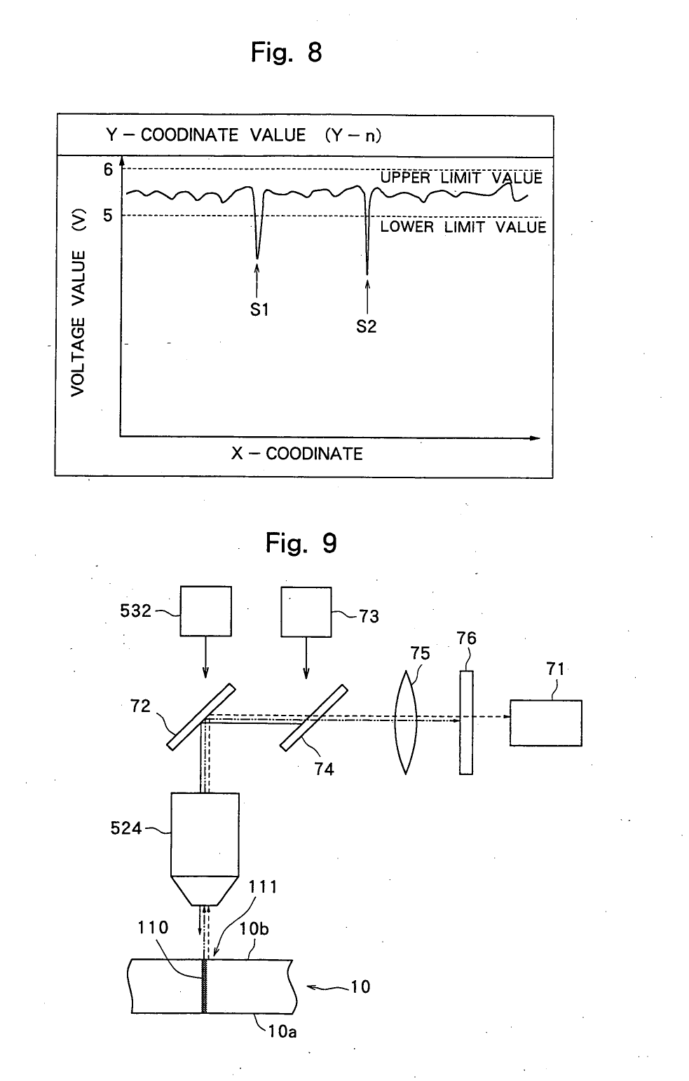

That is, in the laser beam machine in the illustrated embodiment, as shown in FIG. 7, light of a processing portion 111 (top surface of the semiconductor wafer 10 to which a laser beam is applied) is detected by the photodiode 71 of the light detection means 7 attached to the condenser 524. This photo diode 71 detects a laser beam (processing laser beam) that is applied to the processing portion 111 by the laser beam application means 52, converts the intensity of its diffused light into a voltage value and transmits it as a voltage signal to the control means 8 (see FIG. 1). FIG. 8 shows the voltage signal output from the photodiode 71. FIG. 8 shows X-coordinate data at a predetermined Y-coordinate value (Y-n). The axis of abscissa shows the X-coordinate and the axis of ordinates is a voltage value (V) output from the photodiode 71. The X-coordinate can be obtained based on the number of pulses to be applied to the pulse motor 372 of the processing-feed means 37 when the chuck table 36 is moved in the processing-feed direction from a predetermined standard position, and the Y-coordinate value can be obtained based on the number of pulses to be applied to the pulse motor 382 of the first indexing-feed means 38 or the pulse motor 432 of the second indexing-feed means 43 when the chuck table 36 is moved in the indexing-feed direction from a predetermined standard position. In FIG. 8, the voltage value corresponding to the light intensity of the processing portion in which the deteriorated layer is exposed to the top surface of the semiconductor wafer 10 is in the range of 5 to 6 V (permissible range). When the deteriorated layer is not exposed to the top surface of the semiconductor wafer 10, the voltage value outputted from the photodiode 71 drops. That is, as shown by S1 and S2 in FIG. 8, the output voltages from the photodiode 71 corresponding to the areas shown by F1 and F2 in FIG. 6 drop.

As described above, the control means 8 which has received an output signal from the photodiode 71 temporarily stores the X-coordinate data at the predetermined Y-coordinate value (Y-n) shown in FIG. 8, in the random access memory (RAM) 83. The above work is carried out on all the streets 101 formed on the semiconductor wafer 10, and the obtained data are temporarily stored in the random access memory (RAM) 83. The control means 8 which has temporarily stored data on the states of the deteriorated layers formed along all the streets 101 of the semiconductor wafer 10 in the random access memory (RAM) 83 judges whether there exist data having voltage data below (or above) the above permissible range in the resulting data, and if such abnormal data exist, the control means 8 further judges that an area where the deteriorated layer is not exposed to the top surface of the semiconductor wafer 10 is produced, and the data thus judged are stored as failure site data in the storage domain of the random access memory (RAM) 83 as a storage means. Then, the control means 8 displays this failure site data on the display means 9 as required. In the illustrated laser beam machine, as the failure site of the semiconductor wafer 10 that has been processed by a laser beam can be confirmed from the above-described failure site data, re-processing can be carried out according to circumstances or the data can be effectively used for the analysis of a failure.

A description is subsequently given of another example of the light detection means 7 for detecting the light of the processing portion with reference to FIG. 9.

The light detection means 7 shown in FIG. 9 applies light having a wavelength different from that of the processing laser beam from an illuminating light source to the processing portion and detects its reflected light by means of the photodiode 71. That is, the light detection means 7 shown in FIG. 9 comprises a first half mirror 72 interposed between the transmission optical system 523 and the condenser 524 of the laser beam application means 52 shown in FIG. 2, an illuminating light source 73, a second half mirror 74 for reflecting light from the illuminating light source. 73 toward the first half mirror 72, an image-forming lens 75 interposed between the second half mirror 74 and the photodiode 71, and a filter 76. The above illuminating light source 73 is, for example, a laser diode for applying a laser beam having a wavelength different from the wavelength of a laser beam (processing laser beam) applied by the laser beam application means 52. The light from the illuminating light source 73 maybe visible light or near infrared light having a wavelength of about 0.8 μm. The above image-forming lens 75 is not always necessary but when it is provided, the processing-portion 111 can be detected at a high detection magnification. The above filter 76 has the function of cutting off light having the same wavelength as the processing laser beam.

The light detection means 7 shown in FIG. 9 is constituted as described above, and its function will be described herein under. The laser beam (processing laser beam) is applied from the transmission optical system 523 of the laser beam application means 52 to the semiconductor wafer 10 as the work piece through the first half mirror 72 and the condenser 524 with its focusing point on the inside of the semiconductor wafer 10. As a result, the deteriorated layers 110 are formed in the inside of the semiconductor wafer 10 as described above. This processing laser beam is reflected from the processing portion (top surface of the semiconductor wafer 10 to which the processing laser beam is applied) and reaches the filter 76 through the condenser 524, the first half mirror 72, the second half mirror 74 and the image-forming lens 75 as shown by a two-dotted line. Since the filter 76 cuts off light having the same wavelength as the processing laser beam, the reflected light of the processing laser beam does not reach the photo diode 71. Meanwhile, the laser beam for illumination, which has a wavelength different from the wavelength of the processing laser beam and is applied from the illuminating light source 73 that is composed of a laser diode, is applied to a laser processing portion 111 of the semiconductor wafer 10 as the workpiece through the second half mirror 74, the first half mirror 72 and the condenser 524 as shown by a solid line. The reflected light of the laser beam for illumination applied to the laser processing portion 111 of the semiconductor wafer 10 reaches the photodiode 71 through the condenser 524, the first half mirror 72, the second half mirror 74, the image-forming lens 75 and the filter 76 as shown by a broken line. As a result, the photodiode 71 outputs a voltage value corresponding to the intensity of only the reflected light of the laser beam for illumination applied from the illuminating light source 73.

1. A laser beam machine comprising a chuck table for holding a workpiece and a laser beam application means for applying a laser beam to the workpiece held on the chuck table, wherein
the machine further comprises a light detection means for detecting light of a processing portion of the workpiece to which a laser beam is applied from the laser beam application means and a control means for judging whether the output value of the light detection means falls within a predetermined permissible range.

2. The laser beam according to claim 1, wherein the light detection means comprises a photodiode that detects a laser beam applied to the processing portion by the above laser beam application means and converts the intensity of its diffused light into a voltage value.

3. The laser beam machine according to claim 1, wherein the light detection means has an illuminating light source for applying light having a wavelength different from the wavelength of the laser beam applied from the laser beam application means to the processing portion and a photodiode for detecting a reflected light of the light applied to the processing portion from the illuminating light source and converting the intensity of its reflected light into a voltage value.

4. The laser beam machine according to claim 3, wherein the light detection means further comprises a filter for cutting off light having the same wavelength as the wavelength of the laser beam applied from the laser beam application means out of the light reflected from the processing portion.

5. The laser beam machine according to claim 1, wherein the control means comprises a storage means for storing the output value of the light detection means as failure site data when the output value does not fall within the predetermined permissible range.
